(19) United States
(12) Patent Application Publication
(10) Pub. No.: US 2013/0157074 A1
(43) Pub. Date: Jun. 20, 2013

(54) HOLLOW SUPERELASTIC SHAPE MEMORY ALLOY PARTICLES

(71) Applicant: GM GLOBAL TECHNOLOGY OPERATIONS LLC, Detroit, MI (US)

(72) Inventor: Alan L. Browne, Grosse Pointe, MI (US)

(73) Assignee: GM GLOBAL TECHNOLOGY OPERATIONS LLC, Detroit, MI (US)

(21) Appl. No.: 13/686,843

(22) Filed: Nov. 27, 2012

Related U.S. Application Data
(60) Provisional application No. 61/576,123, filed on Dec. 15, 2011.
(60) Provisional application No. 61/576,147, filed on Dec. 15, 2011.

(51) Int. Cl. B32B 15/01

(52) U.S. Cl. CPC B32B 15/01
USPC 428/600; 428/544; 428/613

(57) ABSTRACT

Hollow superelastic shape memory alloy particles are disclosed herein. An example of the hollow superelastic shape memory particle includes an outer shell of a shape memory alloy having an Austenite finish temperature (Af) that is lower than a temperature encountered in an application in which the particle is used so that the shape memory alloy exhibits stress-induced superelasticity. The hollow superelastic shape memory particle also includes an interior hollow portion at least partially surrounded by the outer shell.

### CROSS-REFERENCE TO RELATED APPLICATIONS

This application claims the benefit of U.S. Provisional Application Ser. No. 61/576,123, filed Dec. 15, 2011 and U.S. Provisional Application Ser. No. 61/576,147, filed Dec. 15, 2011.

### TECHNICAL FIELD

The present disclosure relates generally to hollow superelastic shape memory alloy particles.

### BACKGROUND

A shape memory alloy is an alloy material that can be deformed, and then return to its original, pre-deformed shape when exposed to a suitable stimulus (e.g., heat). Shape memory alloys may be one-way materials that remember a single shape and that require deformation to create, for example, a low-temperature shape. Shape memory alloys may also be two-way materials that remember two different shapes, for example, one at low temperatures, and one at high temperatures.

### SUMMARY

Hollow superelastic shape memory alloy particles are disclosed herein. An example of the hollow superelastic shape memory particle includes an outer shell of a shape memory alloy having an Austenite finish temperature (A_{f}) that is lower than a temperature encountered in an application in which the particle is used so that the shape memory alloy exhibits stress-induced superelasticity. The hollow superelastic shape memory particle also includes an interior hollow portion at least partially surrounded by the outer shell.

### BRIEF DESCRIPTION OF THE DRAWINGS

Features and advantages of examples of the present disclosure will become apparent by reference to the following detailed description and the drawings, in which like reference numerals correspond to similar, though perhaps not identical, components. For the sake of brevity, reference numerals or features having a previously described function may or may not be described in connection with other drawings in which they appear.

FIG. 1 is a stress and temperature based phase diagram for a shape memory alloy;

FIG. 2 is a cross-sectional, schematic illustration of the behavior of an example of the hollow superelastic SMA particle disclosed herein;

FIG. 3 is a cross-sectional view of an example of the hollow superelastic SMA particle having an irregular geometric shape;

FIG. 4 is a cross-sectional view of an example of the hollow superelastic SMA particle having pores formed in the outer shell;

FIG. 5 is a cross-sectional view of an example of the hollow superelastic SMA particle having an incomplete outer shell; and

FIG. 6 is a cross-sectional view of an example of the hollow superelastic SMA particle having an outer shell with a varying wall thickness.

### DETAILED DESCRIPTION

Example(s) of the hollow, superelastic shape memory alloy (SMA) particles as disclosed herein may be used in a variety of applications. As examples, the particles may be used as additives in magnetorheological fluids (MR fluids), adhesives (e.g., used in joining), anti-slip coatings, etc.; or as fillers in structural components (e.g., composite panel or structures, rubber articles such as engine mounts, bushings, etc., and/or the like); or as a protective liner or a sub-skin in sports equipment; or as an energy absorber in a crash box; etc. It is also envisioned that the hollow, superelastic shape memory alloy particles may be useful in a variety of industries, including, for example, the automotive industry, the construction industry, and the aerospace industry.

In plots of stress versus strain, any cyclic variation in stress creates a loop on the plot. The area of that loop is equal to the mechanical energy dissipated as heat. It has been found that during superelastic deformation (discussed in detail below), internal interfaces between the Austenite and Martensite phases dissipate a substantial amount of available mechanical energy during their formation and motion. It is believed that up to 90% energy dissipation may be exhibited. It is also believed that the dissipation of mechanical energy may impart some mechanical damping characteristics to the superelastic SMA. It is believed that the hollow superelastic SMA particles disclosed herein may advantageously be incorporated into automotive or other structural members for damping of sound wave propagation and/or vibrations, due, at least in part, to the presence of these damping characteristics. As an example, the dry hollow superelastic SMA particles may be packed in a constraining cylinder in order to dissipate energy by stroking. The packed dry hollow superelastic SMA particles may also be used as an isolation element (e.g., for seats and equipment) for mitigation of blast, crash, and/or impact events.

It is also believed that the hollow superelastic SMA particles disclosed herein may be included as an additive to MR fluids to increase the shear strength and thus the stroking forces in an MR piston/damper configuration. The hollow superelastic SMA particles added to an MR fluid may also be used as an isolation element for mitigation of blast, crash, and/or impact events.

In an example, it is believed that the SMA may dampen both low and high frequencies, such as from about 1 Hz to about 200 Hz for vibrations (e.g., road-induced vibrations) and from about 20 Hz to about 20,000 Hz for acoustic frequencies. Dampening may be achieved across such wide ranges, for example, when a plurality of the hollow superelastic SMA particles having a size distribution is utilized (i.e., larger particles and smaller particles) and/or when a plurality of hollow superelastic SMA particles having a wall thickness distribution is utilized (i.e., hollow particles having thinner walls and hollow particles having thicker walls).

Superelastic SMAs, while in the superelastic state, are highly deformable, and exhibit shape memory characteristics; i.e., they have the ability to recover their original geometry after the deformation when subjected to an appropriate stimulus (i.e., when stress that causes the deformation is removed). It is believed that the hollow superelastic SMA particles in the examples disclosed herein may exhibit high wear resistance, high strength, high cycle fatigue life, high fracture toughness, and/or high mechanical hysteresis (i.e., will be effective in damping vibrations and reducing sound transmission/propagation). Depending upon the application in which the particles are used, the particles may also increase suspension stability (i.e., reduce settling of magnetic particles in an MR carrier fluid without having to use an anti-settling agent in the fluid) and/or enhance yield stress.

It is further believed that the superelastic SMA particles having a hollow geometric form reduce the overall weight of the object in which they are included, and may also enhance the structural life of the object, e.g., in response to a physical impact. For instance, while exhibiting stress-induced superelasticity (which will be described in further detail below), the SMA enhances energy absorption (e.g., by the flexibility of the hollow SMA particles) when the object is exposed to some type of physical impact. The enhancement in energy absorption may thus increase a crush efficiency of the object, which may in turn increase the elastic limit and ultimate strain (i.e., the strain that the object or material may be subjected to before the strain overcomes the structural integrity of the member). In this way, the object including the superelastic SMA may be able to dissipate and absorb energy associated with higher energy impacts than those objects that do not include the superelastic SMAs.

It is generally known that SMAs are a group of metallic materials that are able to return to a defined shape, size, etc. when exposed to a suitable stimulus. SMAs undergo phase transitions in which yield strength (i.e., stress at which a material exhibits a specified deviation from proportionality of stress and strain), stiffness, dimension, and/or shape are altered as a function of temperature. In the low temperature or Martensite phase, the SMA is in a deformable phase, and in the high temperature of Austenite phase, the SMA returns to the remembered shape (i.e., prior to deformation). SMAs are also stress-induced SMAs (i.e., superelastic SMAs), which will be described further hereinbelow.

When the shape memory alloy is in the Martensite phase and is heated, it begins to change into the Austenite phase. The Austenite start temperature (Aₛ) is the temperature at which this phenomenon starts, and the Austenite finish temperature (A_{f}) is the temperature at which this phenomenon is complete. When the shape memory alloy is in the Austenite phase and is cooled, it begins to change into the Martensite phase. The Martensite start temperature (Mₛ) is the temperature at which this phenomenon starts, and the Martensite finish temperature (M_{f}) is the temperature at which this phenomenon finishes.

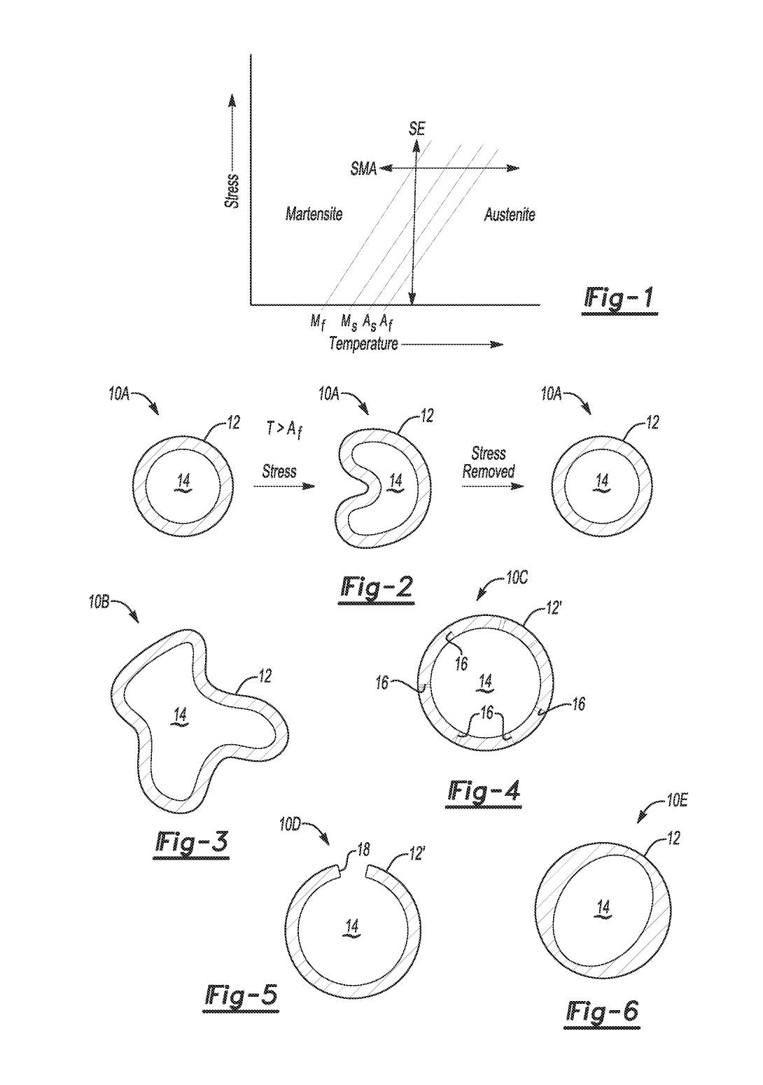

FIG. 1 illustrates a stress and temperature based phase diagram for a shape memory alloy. The SMA horizontal line represents the temperature based phase transition between the Martensitic and Austenitic states at an arbitrarily selected level of stress. In other words, this line illustrates the temperature based shape memory effect previously described herein.

Superelasticity (SE) occurs when the SMA is mechanically deformed at a temperature that is above the A_{f} of the SMA. In an example, the SMA is superelastic from the A_{f} of the SMA to about A_{f} plus 50° C. The SMA material formulation may thus be selected so that the range in which the SMA is superelastic spans a major portion of a temperature range of interest for an application in which the hollow superelastic SMA particles will be used. As an example, it may be desirable to select an SMA having an A_{f} of 0° C. so that the superelasticity of the material is exhibited at temperatures ranging from 0° C. to about 50° C. Other examples of suitable SMA materials have an Austenite finish temperature A_{f} ranging from a cryogenic temperature (e.g., −150° C.) to in excess of 150° C.

This type of deformation (i.e., mechanical deformation at a temperature that is above the A_{f} of the SMA) causes a stress-induced phase transformation from the Austenite phase to the Martensite phase. Application of sufficient stress when an SMA is in its Austenite phase will cause the SMA to change to its lower modulus Martensite phase in which the SMA can exhibit up to 8% of “superelastic” deformation (i.e., recoverable strains on the order of up to 8% are attainable). The stress-induced Martensite phase is unstable at temperatures above the A_{f}, so that removal of the applied stress will cause the SMA to switch back to its Austenite phase. The application of an externally applied stress causes the Martensite phase to form at temperatures higher than the Martensite start temperature associated with a zero stress state (see FIG. 1). As such, the Martensite start temperature (Mₛ) is a function of the stress that is applied. Superelastic SMAs are able to be strained several times more than ordinary metal alloys without being plastically deformed. However, this characteristic is observed over a specific temperature range of A_{f} to A_{f}plus 50° C., and the largest ability to recover occurs within this range. An example of the deformation and subsequent shape recovery of one hollow superelastic SMA particle 10A is shown in FIG. 2.

The temperature at which the SMA remembers its high temperature form may be altered, for example, by changing the composition of the alloy and through heat treatment. The composition of an SMA may be controlled to provide an A_{f} that is below the operating temperature of the application in which the particles are being used, so that the SMA particles will behave superelastically when sufficient stress is applied. In an example, the A_{f} is selected to be within about 5° C. below the operating temperature of the application in which the superelastic SMA particles are being used.

As mentioned above, the hollow superelastic SMA particles exhibit stress-induced superelasticity when at temperatures greater than the Austenite finish temperature (A_{f}) of the particular SMA. Some examples of the superelastic SMA that may be used herein include nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. Some specific examples include alloys of copper-zinc-aluminum-nickel, copper-aluminum-nickel, nickel-titanium, zinc-copper-gold-iron, gold-cadmium, iron-platinum, titanium-niobium, gold-copper-zinc, iron-manganese, zirconium-cobalt, zinc-copper, and titanium-vanadium-palladium. Examples of nickel-titanium based alloys include alloys of nickel and titanium, alloys of nickel, titanium, and platinum, alloys of nickel, titanium, and palladium, or alloys of nickel, titanium and at least one other metal.

As shown in all of FIGS. 2 through 6, the hollow superelastic SMA particles 10A, 10B, 10C, 10D, 10E include an outer shell 12 fully or partially surrounding a hollow interior 14. The outer shell 12 may be complete (shown as 12) or incomplete (12′). A complete shell 12 has a continuous, non-porous exterior. The surface of the complete shell may be smooth or may have surface irregularities, such as protrusions, bumps, indentations, dimples, or cavities, formed therein. The surface irregularities of the complete shell 12 may be protrusions, bumps, etc. extending out of the surface of the complete shell or dents, cavities, dimples, etc. formed in the surface of the complete shell 12, but these irregularities do not extend through the shell 12 to the interior 14. It is believed that the presence of surface irregularities may help produce enhanced mechanical component of bonding (mechanical interlock) in a system in which the particles are embedded. Examples of complete shells 12 are shown in FIGS. 2, 3 and 6. The example shown in FIG. 3 has a deeply curved, but complete surface.

An incomplete shell 12′ may include pore(s), hole(s), crack(s), void(s), gap(s), etc. that extend from the surface of the outer shell 12′ through the thickness of the outer shell 12′ so that the hollow interior 14 of the particle is exposed. An incomplete shell 12′ may include a single pore, hole, crack, etc., or may include a plurality of pores, holes, cracks, etc. Examples of incomplete shells 12′ are shown in FIGS. 4 and 5. In particular, FIG. 4 illustrates a plurality of pores 16 and FIG. 5 illustrates a single crack, break, gap, etc. 18 in the outer shell 12′.

The superelastic SMA may have any regular geometric shape (e.g., including regular three-dimensional shapes) or any irregular geometric shape (including irregular three-dimensional shapes). As examples, the hollow superelastic SMA particles may be perfect or imperfect hollow spheres, hollow prisms, hollow pyramids, hollow cylinders, etc. As other examples, the exterior surface of the particles may be curved, angular, or combinations thereof An example of a particle 10A having a regular geometric shape is shown in FIG. 2 while an example of a particle 10B having an irregular geometric shape is shown in FIG. 3. In some cases, the hollow particles within a plurality of particles include at least some different and random shapes (e.g., some particles are spheres, some are cylinders, some particles are irregularly shaped, etc.).

It is believed that hollow particles have a relatively low mass due to a relatively thin wall (i.e., shell) thickness and a lower net density of the individual SMA particles 10A, 10B, 10C, 10D, 10E. In an example, if the wall thickness is less than 5% of the radius of the particle 10A, 10B, 10C, 10D, 10E, the mass/weight of the particle 10A, 10B, 10C, 10D, 10E will be less than the mass/weight of an equivalent volume of a typical lubricating oil. As such, the hollow superelastic SMA particles 10A, 10B, 10C, 10D, 10E may impart little weight to the object, material etc. in which the particles are included.

While the desirable wall thickness of the hollow superelastic SMA particles 10A, 10B, 10C, 10D, 10E may vary depending upon the application in which the particles 10A, 10B, 10C, 10D, 10E are used, as an example, the wall thickness may range from about 1 μm to about 500 μm. This range may vary depending upon the total size (e.g., the diameter measured from one side of the exterior surface to another side of the exterior surface) of the particle 10A, 10B, 10C, 10D, 10E. The upper limit of the wall thickness may be any thickness that is less than 100% of the radius of the particle. When the wall thickness increases, the particles tend to exhibit more stiffness. In general, stiffness approaches its greatest value when the radius of the interior 14 shrinks to nearly zero. As such, the wall thickness may be varied depending upon a desirable stiffness of the hollow superelastic SMA particles.

The wall thickness of a single particle may be consistent, or it may vary. A varying wall thickness is shown in FIG. 6, where some portions of the outer shell 12 are thicker than other portions of the outer shell 12.

It is to be understood that the size of the hollow superelastic SMA particles 10A, 10B, 10C, 10D, 10E used in a single application may be relatively consistent or may vary (i.e., a distribution of particle sizes may be used). The particle size generally refers to the diameter of the particle 10A, 10B, 10C, 10D, 10E measured from one point on the exterior surface of the outer shell 12, 12′ to another point on the exterior surface of the outer shell 12, 12′. When the particle has an irregular shape, an average diameter may be taken to determine the size of the particle. As an example, the particles 10A, 10B, 10C, 10D, 10E disclosed herein may have a size ranging from about 20 μm to about 20 mm. The size of the particles 10A, 10B, 10C, 10D, 10E may also depend upon the application in which the particles 10A, 10B, 10C, 10D, 10E are to be used.

While a variety of different shapes and configurations of the particles 10A, 10B, 10C, 10D, 10E have been described, it is to be understood that the form of the particle 10A, 10B, 10C, 10D, 10E may be dictated by the application in which the particle 10A, 10B, 10C, 10D, 10E is to be used. For example, superelastic SMA particles having a complete shell 12 may be desirable in applications where light weight is desirable, such as inclusion in MR fluids, inclusion in polymer(s) prior to curing, etc.

In still other examples, the outer shell 12 or 12′ surrounds an interior material (not shown) that is present in the hollow interior 14. In these examples, the particles are no longer hollow, but rather the superelastic SMA outer shell 12, 12′ forms a skin on another core material. The core material present in the interior 14 may be selected from a variety of materials.

In an example, the core material may be a sacrificial scaffolding/template that enables the formation of the outer shell 12, 12′. In this example, if the outer shell is an incomplete outer shell 12′, then the sacrificial scaffolding/template may be removed through the pore(s), hole(s), etc. to obtain the hollow particle. Removal of the sacrificial scaffolding/template may depend upon the material of which the scaffolding/template is formed. As an example, removal may be accomplished if the sacrificial scaffolding/template is a brittle material, such as a ceramic. In this case, deforming the shell 12′ will cause the scaffolding/template to break. Performing deformation multiple times may break the scaffolding/template into small particles that can be removed through the pore(s), hole(s), etc. The sacrificial scaffolding/template may also be made of a material that can be dissolved by a suitable chemical. For example, a scaffolding/template made of iron could be dissolved by adding cola and then pouring the dissolved contents out of the pore(s), hole(s), etc. to obtain the hollow interior 14.

For another example, the core material may be a foam material or a solid material. In some instances, the density of the core material is greater than the superelastic SMA outer shell 12, 12′; and in other instances, the density of the core material is less than the superelastic SMA outer shell 12, 12′. The core material may also be a hollow particle upon which the superelastic SMA outer shell 12, 12′ is formed. In these instances, the hollow core material may be formed of ceramic, metal, glass, or another material surrounding a hollow interior.

It is to be understood that the ranges provided herein include the stated range and any value or sub-range within the stated range. For example, a range from about 100° C. to about 300° C. above A_{f} should be interpreted to include not only the explicitly recited limits of about 100° C. to about 300° C. above A_{f}, but also to include individual values, such as 105° C., 150° C., 175° C., 200° C. above A_{f} etc., and sub-ranges, such as from about 150° C. to about 250° C., from about 180° C. to about 295° C., etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described, it will be apparent to those skilled in the art that the disclosed examples may be modified. Therefore, the foregoing description is to be considered non-limiting.

1. A hollow superelastic shape memory particle, comprising:
an outer shell of a shape memory alloy having an Austenite finish temperature (A_{f}) that is lower than a temperature encountered in an application in which the particle is used so that the shape memory alloy exhibits stress-induced superelasticity; and
an interior hollow portion at least partially surrounded by the outer shell.

2. The hollow superelastic shape memory particle as defined in claim 1 wherein the outer shell has a wall thickness ranging from about 1 μm to about 500 μm.

3. The hollow superelastic shape memory particle as defined in claim 2 wherein the wall thickness varies.

4. The hollow superelastic shape memory particle as defined in claim 1 wherein the outer shell has a wall thickness that is less than 5% of a radius of the particle.

5. The hollow superelastic shape memory particle as defined in claim 1 wherein the shape memory alloy is chosen from a copper-zinc-aluminum-nickel alloy, a copper-aluminum-nickel alloy, a nickel-titanium alloy, a zinc-copper-gold-iron alloy, a gold-cadmium alloy, an iron-platinum alloy, a titanium-niobium alloy, a gold-copper-zinc alloy, an iron-manganese alloy, a zirconium-cobalt alloy, a zinc-copper alloy, and a titanium-vanadium-palladium alloy.

6. The hollow superelastic shape memory particle as defined in claim 1 wherein the outer shell is non-porous.

7. The hollow superelastic shape memory particle as defined in claim 6 wherein the non-porous outer shell includes surface irregularities.

8. The hollow superelastic shape memory particle as defined in claim 1 wherein the outer shell is porous.

9. The hollow superelastic shape memory particle as defined in claim 8 wherein the porous outer shell includes a single gap.

10. The hollow superelastic shape memory particle as defined in claim 8 wherein the porous outer shell includes a plurality of pores.

11. The hollow superelastic shape memory particle as defined in claim 1 wherein a diameter of the particle ranges from about 20 μm to about 20 mm.

12. The hollow superelastic shape memory particle as defined in claim 1 having a shape selected from regular three-dimensional geometric shapes and irregular three-dimensional geometric shapes.

13. The hollow superelastic shape memory particle as defined in claim 12 wherein the regular three-dimensional geometric shape is selected from a sphere, a prism, a pyramid, or a cylinder.

14. The hollow superelastic shape memory particle as defined in claim 1 wherein the Af ranges from about −150° C. to about 150° C.

15. The hollow superelastic shape memory particle as defined in claim 1 wherein the Af is within 5° C. below the temperature encountered in the application in which the particle is used.
